(19) United States
(12) Patent Application Publication
(10) Pub. No.: US 2024/0275815 A1
(43) Pub. Date: Aug. 15, 2024

(54) SYSTEMS, METHODS, AND APPARATUSES FOR ACTIVATING A DECOY RESOURCE BASED ON DURESS TRIGGERS IN AN ELECTRONIC NETWORK

(71) Applicant: BANK OF AMERICA CORPORATION, Charlotte, NC (US)

(72) Inventors: George Anthony Albero, Charlotte, NC (US); Edward Lee Traywick, Bellbrook, OH (US); Maharaj Mukherjee, Poughkeepsie, NY (US); Benjamin Moores, Ventura, CA (US)

(73) Assignee: BANK OF AMERICA CORPORATION, Charlotte, NC (US)

(21) Appl. No.: 18/109,431

(22) Filed: Feb. 14, 2023

(51) Int. Cl. H04L 9/40; G06N 20/00

(52) U.S. Cl. CPC H04L 63/1491; G06N 20/00; H04L 63/102

(57) ABSTRACT

Systems, computer program products, and methods are described herein for activating a decoy resource based on duress triggers in an electronic network. The present invention is configured to receive a resource distribution request, wherein the resource distribution request comprises a resource account identifier; determine a verified unique identifier sequence associated with the resource account identifier; receive an unverified unique identifier sequence associated with the resource distribution request; compare the unverified unique identifier sequence with the verified unique identifier sequence; and determine, based on the comparison of the unverified unique identifier sequence with the verified unique identifier sequence, a duress trigger; and activate, in an instance where the duress trigger is positive, a decoy resource container, wherein the decoy resource container comprises at least one decoy resource.

### FIELD OF THE INVENTION

The present invention embraces a system for activating a decoy resource based on duress triggers in an electronic network.

### BACKGROUND

Managers of electronic networks allowing access to resources and the distribution of resources have a harder time than ever determining when a misappropriation of those resources is attempted and how to prevent the misappropriation without alerting the misappropriator. For instance, a potential misappropriator may use force, coercion, and/or the like to influence a user associated with a resource account in order for the potential misappropriator to gain access to the resources. Further, and where the misappropriator is able to gain access to the resources through the user associated with the resource account, managers of the electronic networks allowing access to resources may need to further prevent the actual resources from being distributed to the misappropriator. Thus, there exists a need for a system to activate a decoy resource based on duress triggers being tracked in an efficient, accurate, and secure manner.

Applicant has identified a number of deficiencies and problems associated with activating a decoy resource based on duress triggers in an electronic network. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for activating a decoy resource based on duress trigger is provided. The system may comprise: a memory device with computer-readable program code stored thereon; at least one processing device operatively coupled to the at least one memory device and the at least one communication device, wherein executing the computer-readable code is configured to cause the at least one processing device to: receive a resource distribution request, wherein the resource distribution request comprises a resource account identifier; determine a verified unique identifier sequence associated with the resource account identifier; receive an unverified unique identifier sequence associated with the resource distribution request; compare the unverified unique identifier sequence with the verified unique identifier sequence; determine, based on the comparison of the unverified unique identifier sequence with the verified unique identifier sequence, a duress trigger, wherein, in an instance where the unverified unique identifier sequence does not match the verified unique identifier sequence, the duress trigger is positive, or wherein, in an instance where the unverified unique identifier sequence does match the verified unique identifier sequence, the duress trigger is negative; and activate, in an instance where the duress trigger is positive, a decoy resource container, wherein the decoy resource container comprises at least one decoy resource.

In some embodiments, the resource distribution request is transmitted from a user interface of at least one of a resource distribution machine or a resource transaction machine.

In some embodiments, the decoy resource comprises a decoy indication.

In some embodiments, the decoy resource comprises a decoy identifier.

In some embodiments, the decoy resource comprises at least one dissolvable attribute. In some embodiments, the at least one dissolvable attribute comprises a water-dissolvable attribute or a light dissolvable attribute.

In some embodiments, the decoy resource comprises a light activation attribute.

In some embodiments, the processing device is further configured to: apply a duress trigger tracking machine learning model to the unverified unique identifier sequence; and generate, by the duress trigger tracking machine learning model, the duress trigger. In some embodiments, the processing device is further configured to: collect a set of verified unique identifier sequences associated with a plurality of resource account identifiers; and train the duress trigger tracking machine learning model using the set of verified unique identifier sequences associated with the plurality of resource account identifiers. In some embodiments, the processing device is further configured to: collect a set of verified unique identifier sequences associated with the resource account identifiers, wherein the set of verified unique identifier sequences comprises data of previous unique identifier sequences associated with the resource account identifier; and train the duress trigger tracking machine learning model using the set of verified unique identifier sequences associated with the resource account identifier.

In some embodiments, the processing device is further configured to allow, in an instance where the duress trigger is negative, the resource distribution request.

In another aspect, a computer program product for activating a decoy resource based on duress triggers is provided. In some embodiments, the computer program product comprises at least one non-transitory computer-readable medium having computer-readable program code portions embodied therein, the computer-readable program code portions which when executed by a processing device are configured to cause the processor to: receive a resource distribution request, wherein the resource distribution request comprises a resource account identifier; determine a verified unique identifier sequence associated with the resource account identifier; receive an unverified unique identifier sequence associated with the resource distribution request; compare the unverified unique identifier sequence with the verified unique identifier sequence; determine, based on the comparison of the unverified unique identifier sequence with the verified unique identifier sequence, a duress trigger, wherein, in an instance where the unverified unique identifier sequence does not match the verified unique identifier sequence, the duress trigger is positive, or wherein, in an instance where the unverified unique identifier sequence does match the verified unique identifier sequence, the duress trigger is negative; and activate, in an instance where the duress trigger is positive, a decoy resource container, wherein the decoy resource container comprises at least one decoy resource.

In some embodiments, the resource distribution request is transmitted from a user interface of at least one of a resource distribution machine or a resource transaction machine.

In some embodiments, the decoy resource comprises a decoy indication.

In some embodiments, the decoy resource comprises a decoy identifier.

In some embodiments, the decoy resource comprises at least one dissolvable attribute.

In another aspect, a computer-implemented method for activating a decoy resource based on duress triggers is provided. In some embodiments, the computer-implemented method may comprise: receiving a resource distribution request, wherein the resource distribution request comprises a resource account identifier; determining a verified unique identifier sequence associated with the resource account identifier; receiving an unverified unique identifier sequence associated with the resource distribution request; comparing the unverified unique identifier sequence with the verified unique identifier sequence; determining, based on the comparison of the unverified unique identifier sequence with the verified unique identifier sequence, a duress trigger, wherein, in an instance where the unverified unique identifier sequence does not match the verified unique identifier sequence, the duress trigger is positive, or wherein, in an instance where the unverified unique identifier sequence does match the verified unique identifier sequence, the duress trigger is negative; and activating, in an instance where the duress trigger is positive, a decoy resource container, wherein the decoy resource container comprises at least one decoy resource.

In some embodiments, the resource distribution request is transmitted from a user interface of at least one of a resource distribution machine or a resource transaction machine.

In some embodiments, the decoy resource comprises a decoy indication.

In some embodiments, the decoy resource comprises a decoy identifier.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for activating a decoy resource based on duress triggers in an electronic network, in accordance with an embodiment of the invention;

FIG. 2 illustrates an exemplary machine learning (ML) subsystem architecture 200, in accordance with an embodiment of the invention;

FIG. 3 illustrates a process flow for activating a decoy resource based on duress triggers in an electronic network, in accordance with an embodiment of the invention;

FIG. 4 illustrates a process flow for generating the duress trigger, in accordance with an embodiment of the invention; and

FIG. 5 illustrates a process flow for training the duress trigger tracking machine learning model, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

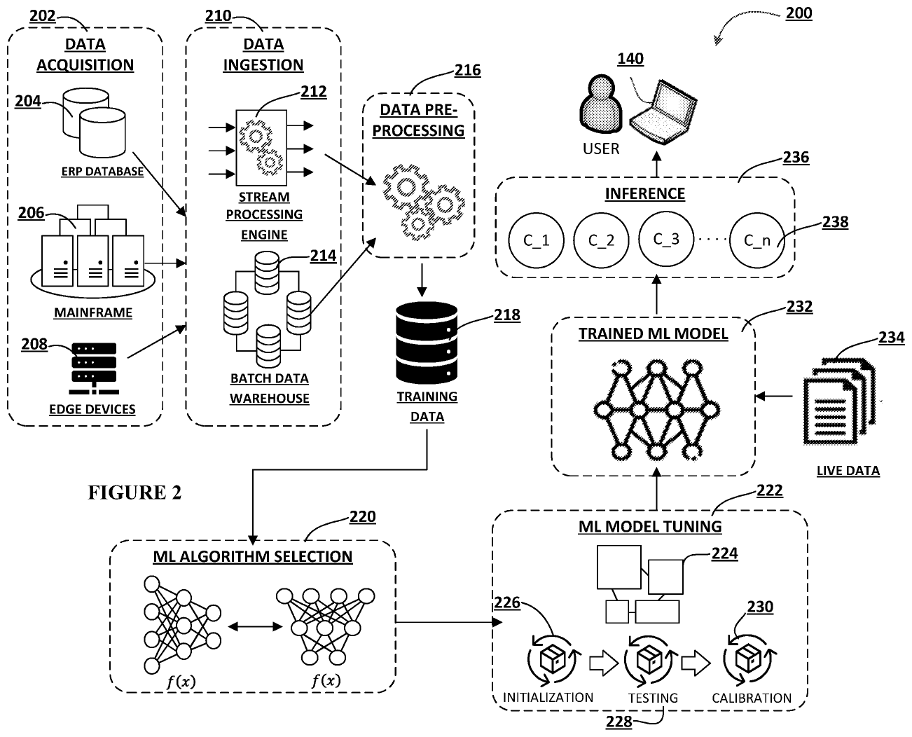

As described in further detail herein, the present disclosure provides a solution to the above-referenced problems in the field of technology by generating an accurate, efficient, and secure decoy resource activation system to prevent misappropriation of resources. Such a system (i.e., a decoy resource activation system) may further track the decoy resources, destroy decoy resources, and/or the like to prevent a misappropriator from using the decoy resources in a resource transaction. The present invention solves these technical problems by implementing the decoy resource activation system—like that shown as system 130—which may further comprise a duress trigger tracking machine learning model—like that shown as machine learning subsystem 200 of FIG. 2. For instance, the decoy resource activation system acts to determine whether a duress trigger is present based at least on receiving an unverified unique identifier sequence (e.g., a PIN, security code, passcode, and/or the like entered by a user at a time when the resource distribution request is submitted), determining whether the unverified unique identifier sequence matches a verified unique identifier sequence (e.g., a verified PIN, verified security code, verified passcode, and/or the like which was previously received and verified for the resource account identifier). Further, the decoy resource activation system may activate a decoy resource container (e.g., such as a drawer) comprising at least one decoy resource when a duress trigger is positive (i.e., present).

Accordingly, the decoy resource activation system by receiving a resource distribution request, wherein the resource distribution request comprises a resource account identifier; determining a verified unique identifier sequence associated with the resource account identifier; and receiving an unverified unique identifier sequence associated with the resource distribution request. Further, the decoy resource activation system may compare the unverified unique identifier sequence with the verified unique identifier sequence; determining, based on the comparison of the unverified unique identifier sequence with the verified unique identifier sequence, a duress trigger, wherein, in an instance where the unverified unique identifier sequence does not match the verified unique identifier sequence, the duress trigger is positive, or wherein, in an instance where the unverified unique identifier sequence does match the verified unique identifier sequence, the duress trigger is negative; and activating, in an instance where the duress trigger is positive, a decoy resource container, wherein the decoy resource container comprises at least one decoy resource.

What is more, the present disclosure provides a technical solution to a technical problem. As described herein, the technical problem includes the accurate, efficient and secure protection of resources in a resource distribution, especially where a misappropriation and/or intimidation is used to coerce a user associated with a resource account to hand over the resource. The technical solution presented herein allows for a decoy resource activation system that accurately, efficiently, and securely determines when a duress trigger is positive and, when the duress trigger is determined to be positive, activate a decoy resource container comprising a decoy resource to be distributed instead of a valid or real resource. In particular, the decoy resource activation system is an improvement over existing solutions to the protection and distribution of resources in a misappropriation or intimidation environment, (i) with fewer steps to achieve the solution, thus reducing the amount of computing resources, such as processing resources, storage resources, network resources, and/or the like, that are being used; (ii) providing a more accurate solution to problem, thus reducing the number of resources required to remedy any errors made due to a less accurate solution (e.g., by training and using a duress trigger tracking machine learning model and an automatic distribution of a decoy resource(s) when a duress trigger is positive); (iii) removing manual input and waste from the implementation of the solution, thus improving speed and efficiency of the process and conserving computing resources; (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

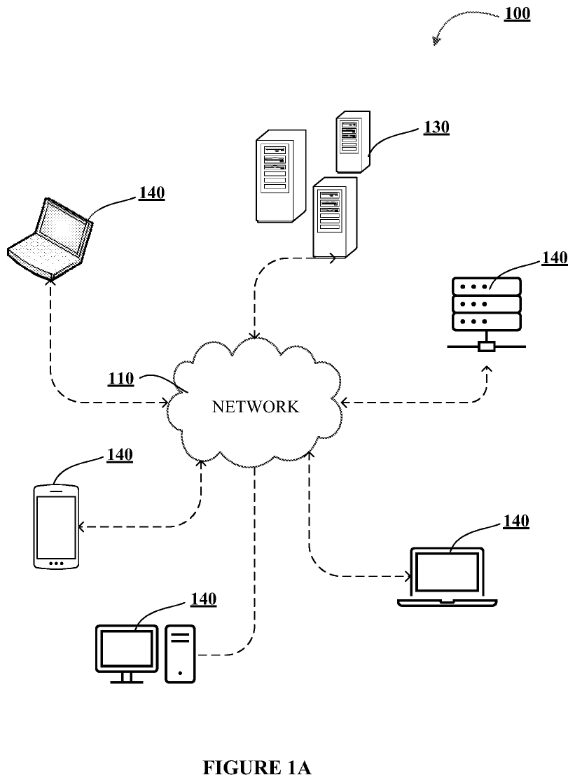

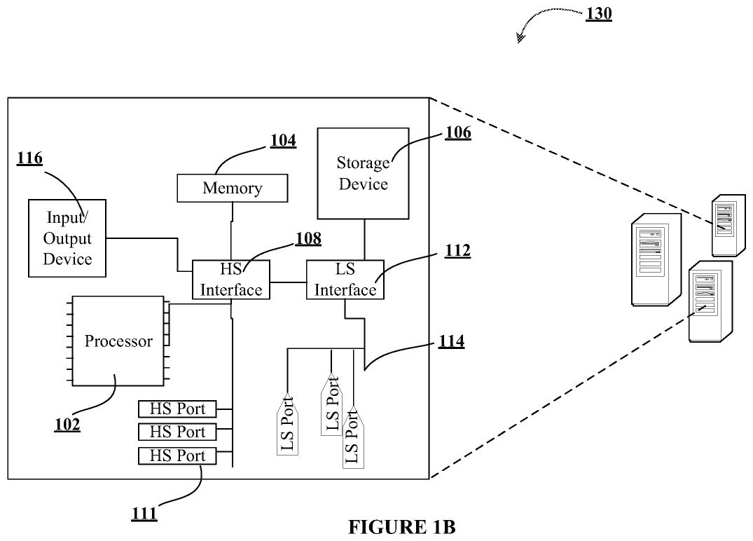

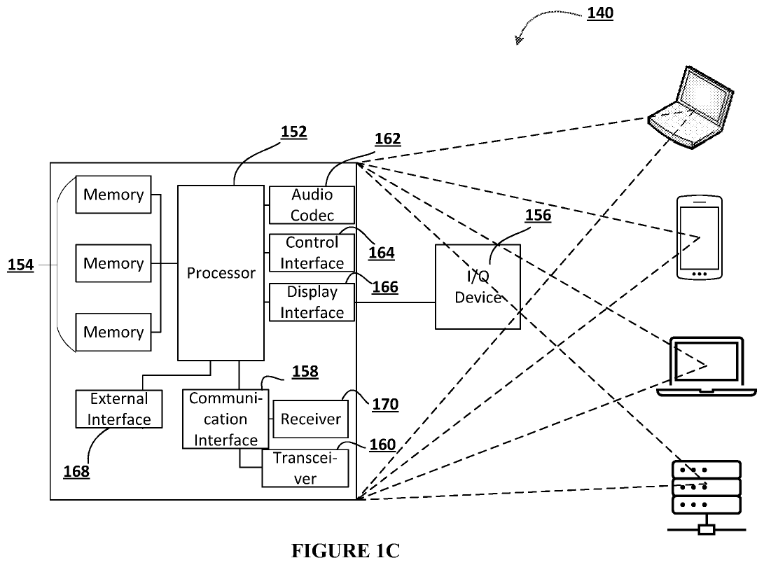

FIGS. 1A-1C illustrate technical components of an exemplary distributed computing environment for activating a decoy resource based on duress triggers in an electronic network 100, in accordance with an embodiment of the invention. As shown in FIG. 1A, the distributed computing environment 100 contemplated herein may include a system 130 (i.e., a decoy resource activation system), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

FIG. 2 illustrates an exemplary machine learning (ML) subsystem architecture 200, in accordance with an embodiment of the invention. The machine learning subsystem herein described may be used as an exemplary illustration of the duress trigger tracking machine learning model and such components and software of the ML subsystem architecture 200 may likewise be implemented for the duress trigger tracking machine learning model. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

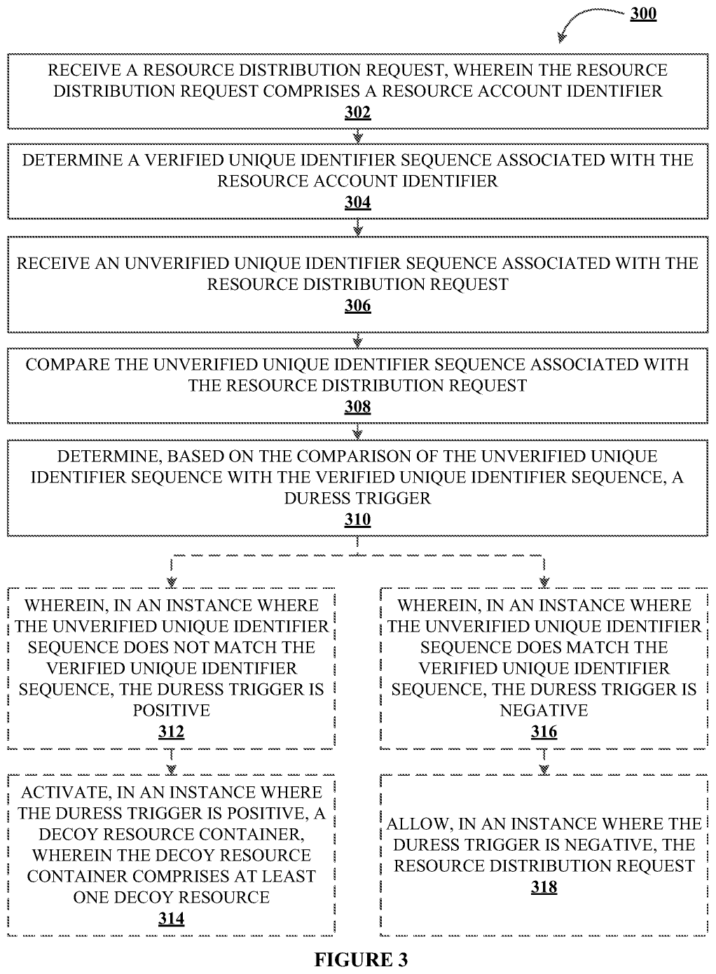

FIG. 3 illustrates a process flow 300 for activating a decoy resource based on duress triggers in an electronic network, in accordance with an embodiment of the invention. In some embodiments, a system (e.g., similar to one or more of the systems described herein with respect to FIGS. 1A-1C) may perform one or more of the steps of process flow 300. For example, a decoy resource activation system (e.g., the system 130 described herein with respect to FIG. 1A-1C) may perform the steps of process 300.

As shown in block 302, the process flow 300 may include the step of receiving a resource distribution request, wherein the resource distribution request comprises a resource account identifier. In some embodiments, the decoy resource activation system may receive a resource distribution request within the decoy resource activation system itself, such as where the decoy resource activation system comprises and/or is attached to a device or component to receive a resource distribution request (e.g., an ATM, a point of sale device, a device linked to one or more financial institutions, and/or the like). In some embodiments, the decoy resource activation system may receive the resource distribution request when in communication with a device configured to receive the resource distribution request, such as when the decoy resource activation system is in electronic communication with an ATM, point of sale device, a device linked to one or more financial institutions, and/or the like, which may communicate the resource distribution request over a network to the decoy resource activation system, such as network 110 of FIG. 1A. For instance, such devices and/or components configured to receive the resource distribution request and transmit the resource distribution request to the decoy resource activation system may be exemplarily shown as components 140 of FIG. 1A. However, and in some embodiments, the decoy resource activation system itself may comprise the devices and/or components configured to receive the resource distribution request (e.g., the decoy resource activation system may comprise the ATM, point of sale device, and/or the like; the decoy resource activation system may be hardwired with the ATM, point of sale device, and/or the like; the decoy resource activation system may be stored within the ATM, the point of sale device, and/or the like; and/or the like).

For instance, and in some embodiments, the resource distribution request may be received at a resource distribution machine (e.g., an ATM) and/or a resource transaction machine (e.g., a point of sale device), by a user (such as a user associated with the resource account) entering the details of the resource account into a user interface of at least one of the resource distribution machine and/or the resource transaction machine. In this manner, at least one of the resource distribution machine and/or resource transaction machine may transmit the resource distribution request to the decoy resource activation system.

In some embodiments, the resource distribution request may comprise a resource account identifier which may be identified by receiving the resource distribution request and parsing the resource distribution request to identify a resource account from which to transfer the resource(s) from. By way of non-limiting example, the decoy resource activation system may parse the resource distribution request, which may comprise a resource account identifier which the user that entered the resource distribution request may be associated with (e.g., the user may be an owner, a manager, and/or the like the of the resource account associated with the resource account identifier). In this manner, the resource account identifier may comprise a unique sequence of alphanumeric characters, a username, a unique sequence of numbers, and/or the like. In some embodiments, the resource account identifier may comprise a resource account number, name, and/or the like, which may uniquely identify the resource account from which a resource is to be distributed from.

As shown in block 304, the process flow 300 may include the step of determining a verified unique identifier sequence associated with the resource account identifier. In some embodiments, the decoy resource activation system may determine the verified unique identifier sequence based on the resource account identifier received and/or identified by the resource distribution request. As used herein, a verified unique identifier sequency may refer to a security code (e.g., a PIN number, a passcode, and/or the like), a unique alphanumeric sequence, and/or the like, associated with the resource account identifier. Such a verified unique identifier sequency may be pre-verified as the proper security code (e.g., proper PIN number, proper passcode, and/or the like), such that when a unique identifier sequence is received by the resource distribution machine and matches the verified unique identifier sequency, received by the resource transmission machine, and/or the like, a resource may be transmitted from the account associated with the resource account identifier. However, and in some embodiments, the decoy resource activation system may receive an unverified unique identifier sequence that may not match the verified unique identifier sequence and may, thus, perform the steps herein described to activate a decoy resource. Such a determination that the unverified unique identifier sequence does not match the verified unique identifier sequence is described in further detail below.

As shown in block 306, the process flow 300 may include the step of receiving an unverified unique identifier sequence associated with the resource distribution request. In some embodiments, the decoy resource activation system may receive an unverified unique identifier sequence associated with the resource distribution request upon receiving the resource distribution request. For instance, and in some embodiments, the decoy resource activation system and/or a device/component configured to receive and transmit the resource distribution request may further request an unverified unique identifier sequence from the user at the same time and/or at an immediate time after receiving the resource distribution request. Such an immediate time after receiving the resource distribution request may comprise a millisecond, five milliseconds, ten milliseconds, one second, five seconds, ten seconds, thirty seconds, a minute, and/or the like after receiving the resource distribution request. In some embodiments, the decoy resource activation system and/or a device/component configured to receive and transmit the resource distribution request may request the unverified unique identifier sequence at the same time the resource distribution request is input (e.g., via a user interface).

As used herein, an unverified unique identifier sequence may refer to a security code (e.g., a PIN number, a passcode, and/or the like), a unique alphanumeric sequence, and/or the like that has been received by the decoy resource activation system (e.g., at the decoy resource activation system itself, at a device configured to receive a resource distribution request, at a component configured to receive a resource distribution request, and/or the like) which has not yet been verified to match the verified unique identifier sequence of the resource account and/or has been determined to not match the verified unique identifier sequence of the resource account.

In some embodiments, the unverified unique identifier sequence may be received at the decoy resource activation system itself when the decoy resource activation system receives the resource distribution request, at a device configured to receive the resource distribution request and the unverified unique identifier sequence, at a component configured to receive the resource distribution request and the unverified unique identifier sequence, and/or the like.

As shown in block 308, the process flow 300 may include the step of comparing the unverified unique identifier sequence associated with the resource distribution request. In some embodiments, the decoy resource activation system may compare the received unverified unique identifier sequence against the identifier or determined verified unique identifier sequence associated with the resource account of the resource distribution request. As used herein, the term compare may refer to an exact matching of the unique sequence of numbers, letters, alphanumeric symbols, and/or the like (e.g., the sequence of numbers for the PIN, which is entered as the unverified unique identifier sequence, is an exact match to the sequence of numbers for the PIN of the verified unique identifier sequence; an exact matching of the input sequence of the number letters, alphanumeric symbols, and/or the like (e.g., the unverified unique identifier sequence is entered in the same sequence, such as using the same sequence of figures—index finger, middle finger, index finger, middle finger—as the verified unique identifier sequence—index finger, middle finger, index finger, middle finger; the unverified unique identifier sequence is entered in the same sequence—such as by the same fingers—and at the same rate as the verified unique identifier sequence—such as the same time it takes to enter the verified unique identifier sequence; the unverified identifier sequence is entered by a user comprising the same physical characteristics as the verified user of the verified unique identifier sequence—such as having the same height, shoulder breadth, eye color, fingerprint; and/or the like), and/or the like.

As shown in block 310, the process flow 300 may include the step of determining, based on the comparison of the unverified unique identifier sequence with the verified unique identifier sequence, a duress trigger. In some embodiments, the decoy resource activation system may determine, based on the comparison of the unverified unique identifier sequence against the verified unique identifier sequence of the resource account, whether a duress trigger is present (i.e., a duress trigger is positive) or whether there is on duress trigger present (i.e., the duress trigger is negative).

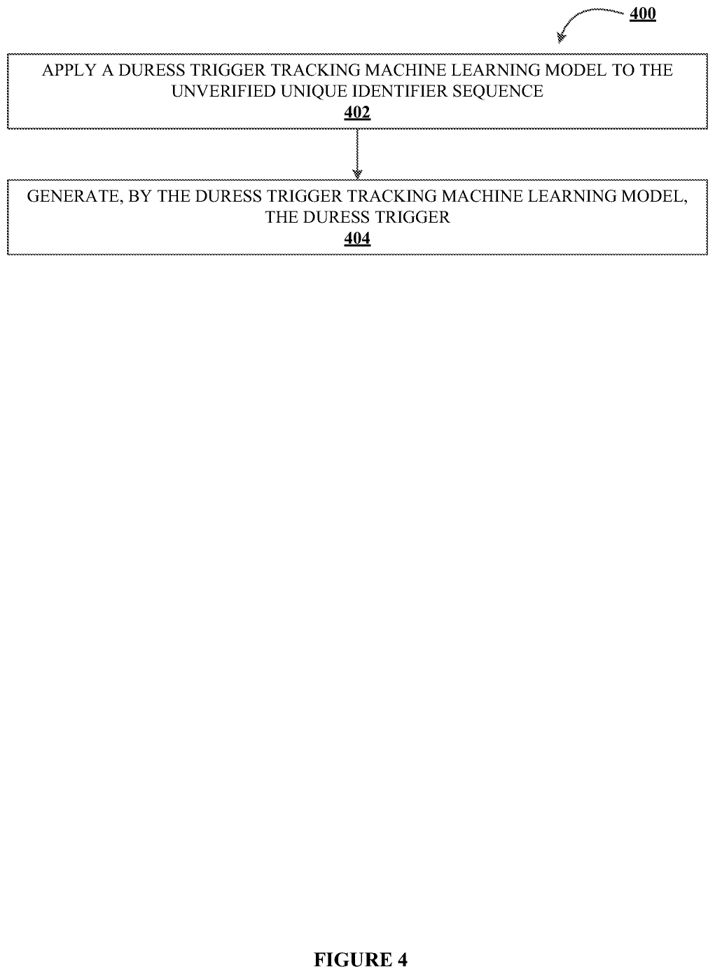

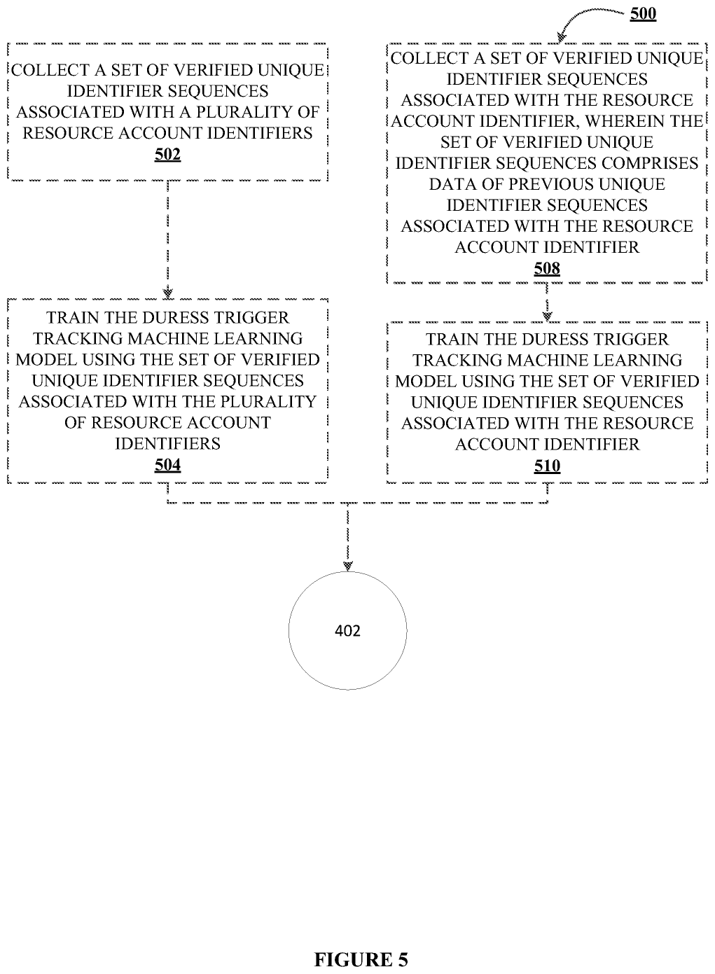

In some embodiments, and as shown in block 312, the process flow 300 may include the step of determining the duress trigger is positive in the instance where the unverified unique identifier sequence does not match the verified unique identifier sequence. In some embodiments, the decoy resource activation system may—when comparing the unverified unique identifier sequence with the verified unique identifier sequence—determine the duress trigger to be positive when the unverified unique identifier sequence does not match the verified unique identifier sequence. For instance, and in some embodiments, the decoy resource activation system may determine at least one of a sequence of the unverified unique identifier sequence and the sequence of the verified unique identifier sequence does not match (e.g., the sequence of fingers used to input the unverified unique identifier sequence—such as middle finger, index finger, middle finger, and index finger—and the verified unique identifier sequence do not match—such as index finger, index finger, middle finger, index finger as a sequence of four inputs, and/or the like); a sequence and a rate of the unverified unique identifier sequence and the sequence and rate of the verified unique identifier sequence does not match (e.g., the sequence of fingers used to input the unverified unique identifier sequence and the verified unique identifier sequence does not and the rate at which the input of the sequence is performed does not match—such as at least one number of the PIN is entered at a different rate, as compared to each number of the PIN for the verified unique identifier sequence); a physical characteristic of the user entering/inputting the unverified unique identifier sequence and the physical characteristic of the user that entered/input the verified unique identifier sequence does not match (e.g., the user that input the unverified unique identifier sequence is five feet eleven inches and the user that entered the verified unique identifier sequence is six feet one inches tall, but each has the same length of shoulder width, both have the same color eyes, and/or the like); and/or the like. In some embodiments, the decoy resource activation system may use a duress trigger tracking machine learning model to determine the presence of the duress trigger. Such a duress trigger tracking machine learning model is described in more detail below with respect to FIGS. 4 and 5.

In some embodiments, and as shown in block 314, the process flow 300 may include the step of activating a decoy resource container in the instance where the duress trigger is positive. In some embodiments, the decoy resource container comprises at least one decoy resource. In some embodiments, the decoy resource activation system may activate a decoy resource container when the decoy resource activation system determines the duress trigger is positive. By way of non-limiting example, the decoy resource container may comprise a drawer and/or compartment which comprises at least one decoy resource.

As used herein, a decoy resource may refer to a fake resource, such as a fake bill, a resource comprising a decoy indication (e.g., a fake bill comprising an indication on its surface indicating the bill has been misappropriated, that the bill should not accepted in a resource transaction, and/or the like), a resource comprising a decoy identifier (e.g., a unique identifier for tracking the resource, such as a unique alphanumeric sequence which may be recorded to track each location of the resource, a unique computer-readable indicia such as a barcode or QR code that may be scanned by a computer to track each location of the resource, and/or the like), and/or the like.

In some embodiments, the decoy resource may comprise at least one dissolvable attribute, such as an attribute used to dissolve the resource completely, dissolve the resource partially (e.g., dissolve the ink on the resource where the resource comprises a piece of paper, and/or the like), such as by a water-dissolvable attribute (e.g., when the resource meets water and/or is engulfed in water, the resource may dissolve completely or partially), a light dissolvable attribute (e.g., a UV light dissolvable attribute where a UV light is shown on the resource, the resource may dissolve completely, partially, and/or the like; a sunlight dissolvable attribute where when the resource meets sunlight, the resource may completely dissolve, partially dissolve, and/or the like), and/or the like.

In some embodiments, the decoy resource may comprise a light activation attribute (e.g., a resource may comprise a UV light activation attribute where a decoy indication may be shown on the surface of the resource when a UV light is shown on the resource, a sunlight activation attribute where a decoy indication may be shown on the surface of the resource when the sunlight is shown on the resource, and/or the like).

In some embodiments, and as shown in block 316, the process flow 300 may include the step of determining the duress trigger is negative in the instance where the unverified unique identifier sequence does match the verified unique identifier sequence. In some embodiments, the decoy resource activation system may—when comparing the unverified unique identifier sequence with the verified unique identifier sequence—determine the duress trigger to be negative when the unverified unique identifier sequence matches the verified unique identifier sequence. For instance, and in some embodiments, the decoy resource activation system may determine at least one of a sequence of the unverified unique identifier sequence and the sequence of the verified unique identifier sequence matches match (e.g., the sequence of fingers used to input the unverified unique identifier sequence—such as index finger, index finger, middle finger, and index finger—and the verified unique identifier sequence does match—such as index finger, index finger, middle finger, index finger as a sequence of four inputs, and/or the like); a sequence and a rate of the unverified unique identifier sequence and the sequence and rate of the verified unique identifier sequence matches (e.g., the sequence of fingers used to input the unverified unique identifier sequence and the verified unique identifier sequence match and the rate at which the input of the sequence is performed matches—such as each number of the PIN is entered at the same rate, like one second per input of the sequence); a physical characteristic of the user entering/inputting the unverified unique identifier sequence and the physical characteristic of the user that entered/input the verified unique identifier sequence matches (e.g., the user that input the unverified unique identifier sequence and the user that entered the verified unique identifier sequence match—such as both are six feet one inches tall, each have the same length of shoulder width, both have the same color eyes, and/or the like); and/or the like. In some embodiments, the decoy resource activation system may use a duress trigger tracking machine learning model to determine the presence of the duress trigger. Such a duress trigger tracking machine learning model is described in more detail below with respect to FIGS. 4 and 5.

In some embodiments, the duress trigger may be determined to be negative where the unverified unique identifier sequence exactly matches the verified unique identifier sequence (i.e., the sequence of the unverified unique identifier sequence matches the sequence of the verified unique identifier sequence, the sequence and the rate of the unverified unique identifier sequence matches the sequence and rate of the verified unique identifier sequence, physical characteristics of the user of the unverified unique identifier sequence matches the physical characteristics of the user of the verified unique identifier sequence, and/or the like).

In some embodiments, and as shown in block 318, the process flow 300 may include the step of allowing the resource distribution request in the instance where the duress trigger is negative. By way of non-limiting example, the decoy resource activation system may allow the resource distribution request (e.g., allow the resource distribution to occur as requested) when the duress trigger is determined to be negative (i.e., where the unverified unique identifier sequences matches the verified unique identifier sequence). In some embodiments, the allowance of the resource distribution request may comprise the distribution and/or transfer of real resources at the device or component configured to receive the resource distribution request (e.g., a distribution of real resources from an ATM, a distribution or transfer of real resources at a point of sale device, and/or the like). As used herein, the phrase “real resource” may refer to a verified and/or certified resource which may be used in resource transactions.

FIG. 4 illustrates a process flow 400 for generating the duress trigger, in accordance with an embodiment of the invention. In some embodiments, a system (e.g., similar to one or more of the systems described herein with respect to FIGS. 1A-1C) may perform one or more of the steps of process flow 400. For example, a decoy resource activation system (e.g., the system 130 described herein with respect to FIG. 1A-1C) may perform the steps of process 400.

As shown in block 402, the process flow 400 may include the step of applying a duress trigger tracking machine learning model to the unverified unique identifier sequence. In some embodiments, the decoy resource activation system may apply a duress trigger tracking machine learning model to the unverified unique identifier sequence and determine whether a duress trigger is present (i.e., a duress trigger is positive) based on the verified unique identifier sequence associated with the resource account identifier. For instance, the duress trigger tracking machine learning model may be trained to determine whether a duress trigger is present (i.e., positive) based on previous instances of the verified unique identifier sequence for the resource account identifier, where the previous instances of the verified unique identifier sequence comprises at least one unique identifier sequence that has been confirmed to not comprise a duress trigger and to have been input by the verified user (i.e., the actual user associated with the resource account).

As shown in block 404, the process flow 400 may include the step of generating, by the duress trigger tracking machine learning model, the duress trigger. In some embodiments, and based on at least the previous instances of the verified unique identifier sequence(s) associated with the resource account identifier and/or other resource account identifiers, the duress trigger tracking machine learning model may generate or determine the duress trigger to be positive (i.e., present) or negative (i.e., not present).

FIG. 5 illustrates a process flow 500 for training the duress trigger tracking machine learning model, in accordance with an embodiment of the invention. In some embodiments, a system (e.g., similar to one or more of the systems described herein with respect to FIGS. 1A-1C) may perform one or more of the steps of process flow 500. For example, a decoy resource activation system (e.g., the system 130 described herein with respect to FIG. 1A-1C) may perform the steps of process 500.

In some embodiments, and as shown in block 502, the process flow 500 may include the step of collecting a set of verified unique identifier sequences associated with a plurality of resource account identifiers. By way of non-limiting example, the decoy resource activation system may collect a set of verified unique identifier sequences associated with a plurality of different resource account identifiers in order to train the duress trigger tracking machine learning model on the plurality of different resource account identifiers. For instance, the duress trigger tracking machine learning model may be trained to determine a duress trigger for a plurality of resource accounts by looking at each verified unique identifier sequence for each of the resource account identifiers and compare the data of each of the verified unique identifier sequences to determine when a newly received unverified unique identifier sequence does not match the verified unique identifier sequence(s) for the resource account. In this manner, the duress trigger tracking machine learning model may be used to determine each of the duress triggers for all of the resource accounts which receive an unverified unique identifier sequence, where all the resource accounts are associated with the decoy resource activation system, with a device or component associated with the decoy resource activation system, and/or the like.

In some embodiments, and as shown in block 504, the process flow 500 may include the step of training the duress trigger tracking machine learning model using the set of verified unique identifier sequences associated with the plurality of resource account identifiers. By way of non-limiting example, the decoy resource activation system may train the duress trigger tracking machine learning model by applying the set of verified unique identifier sequences and the associated data, where the set of verified unique identifier sequences are associated with a plurality of resource account identifiers to give a broad training for each of the resource accounts that receives an unverified unique identifier sequence to be verified. In some embodiments, the duress trigger tracking machine learning model may be trained using the set of verified unique identifier sequences associated with a plurality of resource account identifiers such that the duress trigger tracking machine learning model may determine or generate the duress trigger to be present (i.e., positive) based on similar duress triggers for other resource accounts. For instance, the duress trigger tracking machine learning model may be trained to look for general duress triggers from a plurality of resource accounts and associated users of each resource account, such as timeliness in inputting the unverified unique identifier sequence (e.g., slower input may indicate a duress trigger is present), sequence of inputting the unverified unique identifier sequence (e.g., inputting the unverified unique identifier sequence with normally un-used fingers, such as the pinky, may indicate a duress trigger is present), and/or the like. In this manner, the duress trigger tracking machine learning model may be trained to identify general cues for duress triggers across a plurality of resource accounts associated with the decoy resource activation system.

Further, and in some embodiments, such a training of the duress trigger tracking machine learning model may be used in FIG. 4 for determining or generating the duress trigger.

In some embodiments, and as shown in block 508, the process flow 500 may include the step of collecting a set of verified unique identifier sequences associated with the resource account identifiers, wherein the set of verified unique identifier sequences comprises data of previous unique identifier sequences associated with the resource account identifier. By way of non-limiting example, the decoy resource activation system may collect a set of verified unique identifier sequences associated with a resource account identifier, where the set of verified unique identifier sequences may have been unique identifier sequences previously received by the decoy resource activation system and verified as coming from the user associated with the resource account where the user was not in duress. Thus, and in some embodiments, the decoy resource activation system may determine the rate at which the unique identifier sequence(s) was input (e.g., the timeliness of the input of each of the characters, numbers, or symbols of the unique identifier sequence), the sequence of inputting the unique identifier sequence(s) (e.g., sequence of fingers used to input the unique identifier sequence), and/or the data regarding the physical characteristics of the user inputting the unique identifier sequence(s) (e.g., the height of the user, the eye color of the user, the shoulder width of the user, and/or the like).

In some embodiments, and as shown in block 510, the process flow 500 may include the step of training the duress trigger tracking machine learning model using the set of verified unique identifier sequences associated with the resource account identifier. By way of non-limiting example, the decoy resource activation system may train the duress trigger tracking machine learning model by applying the verified unique identifier sequences associated with the resource account identifier, and the associated data. In this manner, the duress trigger tracking machine learning model may be trained to determine or generate the duress trigger for particular resource accounts, based on the data of previous unique identifier sequences determined to be verified unique identifier sequences.

In some embodiments, either and/or both of the sets of verified unique identifier sequences associated with the plurality of resource account identifiers and/or associated with the resource account identifier may be used to train the duress trigger tracking machine learning model.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for activating a decoy resource based on duress triggers, the system comprising:
a memory device with computer-readable program code stored thereon;
at least one processing device operatively coupled to the at least one memory device and the at least one communication device, wherein executing the computer-readable code is configured to cause the at least one processing device to:
receive a resource distribution request, wherein the resource distribution request comprises a resource account identifier;
determine a verified unique identifier sequence associated with the resource account identifier;
receive an unverified unique identifier sequence associated with the resource distribution request;
compare the unverified unique identifier sequence with the verified unique identifier sequence;
determine, based on the comparison of the unverified unique identifier sequence with the verified unique identifier sequence, a duress trigger,
wherein, in an instance where the unverified unique identifier sequence does not match the verified unique identifier sequence, the duress trigger is positive, or
wherein, in an instance where the unverified unique identifier sequence does match the verified unique identifier sequence, the duress trigger is negative; and
activate, in an instance where the duress trigger is positive, a decoy resource container, wherein the decoy resource container comprises at least one decoy resource.

2. The system of claim 1, wherein the resource distribution request is transmitted from a user interface of at least one of a resource distribution machine or a resource transaction machine.

3. The system of claim 1, wherein the decoy resource comprises a decoy indication.

4. The system of claim 1, wherein the decoy resource comprises a decoy identifier.

5. The system of claim 1, wherein the decoy resource comprises at least one dissolvable attribute.

6. The system of claim 5, wherein the at least one dissolvable attribute comprises a water-dissolvable attribute or a light dissolvable attribute.

7. The system of claim 1, wherein the decoy resource comprises a light activation attribute.

8. The system of claim 1, wherein the processing device is further configured to:
apply a duress trigger tracking machine learning model to the unverified unique identifier sequence; and
generate, by the duress trigger tracking machine learning model, the duress trigger.

9. The system of claim 8, wherein the processing device is further configured to:
collect a set of verified unique identifier sequences associated with a plurality of resource account identifiers; and
train the duress trigger tracking machine learning model using the set of verified unique identifier sequences associated with the plurality of resource account identifiers.

10. The system of claim 8, wherein the processing device is further configured to:
collect a set of verified unique identifier sequences associated with the resource account identifiers, wherein the set of verified unique identifier sequences comprises data of previous unique identifier sequences associated with the resource account identifier; and
train the duress trigger tracking machine learning model using the set of verified unique identifier sequences associated with the resource account identifier.

11. The system of claim 1, wherein the processing device is further configured to allow, in an instance where the duress trigger is negative, the resource distribution request.

12. A computer program product for activating a decoy resource based on duress triggers, wherein the computer program product comprises at least one non-transitory computer-readable medium having computer-readable program code portions embodied therein, the computer-readable program code portions which when executed by a processing device are configured to cause the processor to:
receive a resource distribution request, wherein the resource distribution request comprises a resource account identifier;
determine a verified unique identifier sequence associated with the resource account identifier;
receive an unverified unique identifier sequence associated with the resource distribution request;
compare the unverified unique identifier sequence with the verified unique identifier sequence;
determine, based on the comparison of the unverified unique identifier sequence with the verified unique identifier sequence, a duress trigger,
wherein, in an instance where the unverified unique identifier sequence does not match the verified unique identifier sequence, the duress trigger is positive, or
wherein, in an instance where the unverified unique identifier sequence does match the verified unique identifier sequence, the duress trigger is negative; and
activate, in an instance where the duress trigger is positive, a decoy resource container, wherein the decoy resource container comprises at least one decoy resource.

13. The computer program product of claim 12, wherein the resource distribution request is transmitted from a user interface of at least one of a resource distribution machine or a resource transaction machine.

14. The computer program product of claim 12, wherein the decoy resource comprises a decoy indication.

15. The computer program product of claim 12, wherein the decoy resource comprises a decoy identifier.

16. The computer program product of claim 12, wherein the decoy resource comprises at least one dissolvable attribute.

17. A computer-implemented method for activating a decoy resource based on duress triggers, the computer-implemented method comprising:
receiving a resource distribution request, wherein the resource distribution request comprises a resource account identifier;
determining a verified unique identifier sequence associated with the resource account identifier;
receiving an unverified unique identifier sequence associated with the resource distribution request;
comparing the unverified unique identifier sequence with the verified unique identifier sequence;
determining, based on the comparison of the unverified unique identifier sequence with the verified unique identifier sequence, a duress trigger,
wherein, in an instance where the unverified unique identifier sequence does not match the verified unique identifier sequence, the duress trigger is positive, or
wherein, in an instance where the unverified unique identifier sequence does match the verified unique identifier sequence, the duress trigger is negative; and
activating, in an instance where the duress trigger is positive, a decoy resource container, wherein the decoy resource container comprises at least one decoy resource.

18. The computer-implemented method of claim 17, wherein the resource distribution request is transmitted from a user interface of at least one of a resource distribution machine or a resource transaction machine.

19. The computer-implemented method of claim 17, wherein the decoy resource comprises a decoy indication.

20. The computer-implemented method of claim 17, wherein the decoy resource comprises a decoy identifier.
